(19) United States
(12) Patent Application Publication
(10) Pub. No.: US 2015/0063569 A1
(43) Pub. Date: Mar. 5, 2015

(54) Information Coding and Transmission Method Based on UDP Network Transmission Protocol

(71) Applicant: NetView Technologies(Shenzhen) Co., Ltd., Shenzhen City (CN)

(72) Inventors: Chuan CHEN, Shenzhen City (CN); Zhong BAO, Shenzhen City (CN); Zhengji TAO, Shenzhen City (CN); Yan XU, Shenzhen City (CN); Yao LU, Shenzhen City (CN)

(73) Assignee: NetView Technologies(Shenzhen) Co., Ltd., Shenzhen City (CN)

(21) Appl. No.: 14/018,813

(22) Filed: Sep. 5, 2013

(51) Int. Cl. H04W 12/08

(52) U.S. Cl. CPC H04W 12/08
USPC 380/270

(57) ABSTRACT

This invention discloses an information coding and transmission method that is based on UDP network transmission protocol. It consists of the following procedures: (1) define data transmitting terminal A; (2) define data transmitting terminal B; (3) data transmitting terminals A and B are pre-agreed; (4) establish mapping relationship between data transmitting terminals A and B; complete data transmission and communication according to characteristic value m. The beneficial effect of this invention lies in that implicit data transmission enables the actually transmitted data to be independent from the method of network information encryption; mapping relationship between data transmitted and actual data is pre-set by the data transmitting terminals A and B, so as to achieve strong confidentiality and enable equipment in the encrypted wireless network to send information to those outside of the network by connectionless means.

### TECHNICAL FIELD

The invention relates to an information coding and transmission method based on UDP network transmission protocol, which is in the field of communication technology.

### BACKGROUND ART

Information encryption helps ensure security of information in wireless network, but it also prevent the equipment in encrypted wireless network to send information to those that do not acquire key or join the same wireless network. The equipment not joining wireless network may include the embedded wireless network equipment that do not support current network encryption algorithm or have weak ability to operate encryption protocol, common wireless network equipment that have not acquire keys temporarily, or equipment in the same wireless network that join other coverage range.

### SUMMARY OF THE INVENTION

This invention aims at providing an information coding and transmission method based on UDP network transmission protocol, which enables equipment in the encrypted wireless network to directly send information to equipment outside of the network by connectionless means.

Aim of this invention is realized by the following technical scheme: an information coding and transmission method based on UDP network transmission protocol, which consists of the following procedures:

(1) Definition of data transmitting terminal A, which is a device connected to the encrypted WLAN and capable of transmitting to other network addresses by adoption of connectionless UDP network transmission protocol;

(2) Definition of data transmitting terminal B, which is a device not connected to the abovementioned WLAN but capable of wireless network functions, while data transmitting terminals A and B are in the coverage range of the same wireless network signals;

(3) Pre-agreement between terminal transmitting terminals A and B: preset a time slot length n and the byte length of information sent during this time slot length. Define different characteristic value m (0 or 1) for Bit s in every byte of the data byte sequence sent to data transmitting terminal B according to the different length s of the actual data byte sequence sent to data transmitting terminal B;

(4) Establishment of mapping relationship between data transmitting terminals A and B: data transmitting terminal A sends data of the same length s for more than one time to data transmitting terminal B during preset time period n, to complete transmission and communication of UDP data.

Byte length of said actual data sent to data transmitting terminal B is shorter than the pre-set byte length sent during this time period length n.

The beneficial effect of this invention lies in that implicit data transmission enables the actually transmitted data to be independent from the method of network information encryption; mapping relationship between data transmitted and actual data is pre-set by the data transmitting terminals A and B, so as to achieve strong confidentiality and enable equipment in the encrypted wireless network to send information to those outside of the network by connectionless means.

### DESCRIPTION OF FIGURES

FIG. 1 shows a schematic diagram of the mapping relationship between character positions of the data packet and actual data byte sequence;

FIG. 2 shows the relationship between character positions of the data packet of repeated contents and the actual data byte sequence.

### DETAILED DESCRIPTION OF THE EMBODIMENTS

Technical scheme of this invention will be further elaborated in the following in combination with the embodiments shown in the drawings, which, however, does not include the contents subject to protection.

An information coding and transmission method based on UDP network transmission protocol includes the following procedures:

(1) Definition of data transmitting terminal A, which is a device connected to the encrypted WLAN and capable of transmitting to other network addresses by adoption of connectionless UDP network transmission protocol;

(2) Definition of data transmitting terminal B, which is a device not connected to the abovementioned WLAN but capable of wireless network functions, while data transmitting terminals A and B are in the coverage range of the same wireless network signals;

(3) Pre-agreement between data transmitting terminals A and B: pre-set a time period length n and information of byte length sent during this time period length n; define difference characteristic value m (0 or 1) for Bit s of every byte in data byte sequence sent to data transmitting terminal B according to the different length s of actual data byte sequence sent to data transmitting terminal B. For example, if length of data in a data packet sent to data transmitting terminal B is 6, define the sixth bit in the first byte in the data byte sequence sent to data transmitting terminal B to 1, or 0 according to the pre-agreement. If the length of data in a data packet sent to data transmitting terminal B is 5, define the fifth bit of the first byte in the data byte sequence sent to data transmitting terminal B to a characteristic value to distinguish it from the byte information with length of 6;

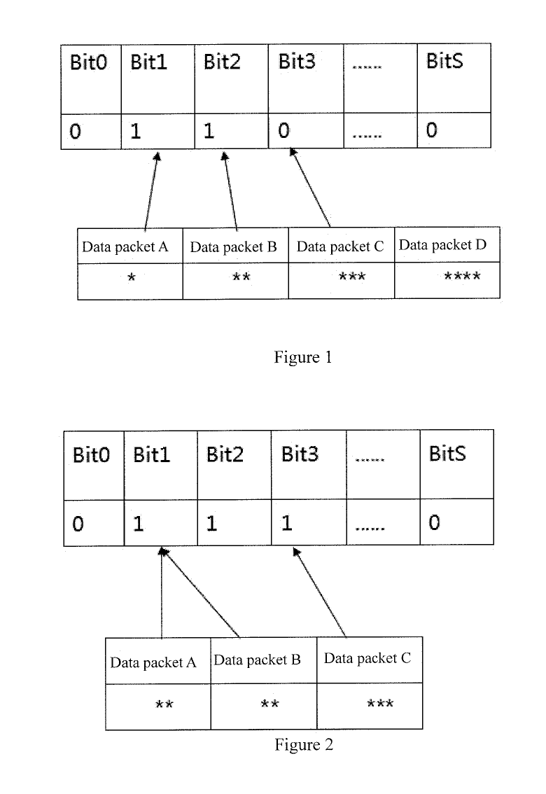

(4) Establishment of mapping relationship between data transmitting terminals A and B: data transmitting terminal A sends data of the same length s for more than one time to data transmitting terminal B during preset time period n, to complete transmission and communication of UDP data. As is shown in FIG. 1 “schematic diagram of mapping relationship between character positions of data packet and actual data byte sequence”, contents in data packets A, B, C, and D do not repeat; data packet A sends data of the same length S1 for more than one time during the pre-set time period n according to byte length S1, while data packet B sends data of the same length S2 for more than one time during the pre-set time period n according to byte length S2. As is shown in FIG. 2, contents of data packets A and B repeat and they have equal byte length. Data packets A and B of the same length are sent for more than one time during pre-set time period n.

Byte length of said actual data sent to data transmitting terminal B is shorter than the pre-set byte length sent during this time period length n.

When current data transmitting terminal A requires sending information to data transmitting terminal B, the information will be sent by connectionless UDP network transmission protocol. Taking 255.255.255.255 for instance, as data transmitting terminal B is in the signal coverage range of wireless network, it is able to sense the information sent to the above network address. Since data transmitting terminal A is in an encrypted wireless network, it sends all information after encryption. As a result, information sent to the above network address and acquired by data transmitting terminal B is encrypted. In addition, since data transmitting terminal B does not join the same encrypted wireless network as data transmitting terminal A and has no key to the encrypted wireless network in advance, data transmitting terminal B will not be able to decrypt and learn the information sent from data transmitting terminal A.

This invention enables equipment in encrypted wireless to directly send information to equipment outside of the network by connectionless means. In this process, encryption method in which the actually transmitted data is independent from network information by implicit data transmission is adopted, and the mapping relationship between the contents of sent data and actual data is pre-set by data transmitting terminals A and B. Therefore, this method provides high confidentiality. Even though the data packet is intercepted by a third party who knows that this coding and transmission method is employed, it will not be able to learn the contents sent from data transmitting terminal A to B.

In this method, when the receiving party receives data of the same value, it will resolve the data into those sent repeatedly for enhancement of transmission reliability. Therefore, confusion due to resolution of information of same value into different information can be prevented. Simple method is used for reliable information transmission in a connectionless and non-reply network environment in which packets may be lost. No special device or software is required on data transmitting terminal A that sends information. It is only required to send UDP data packets to specific address. All wireless network equipment can meet this requirement. No special device is required on data transmitting terminal B that receives information. It is only required to sense data packets sent to specific network address and be able to resolve the contents of the data packets. Therefore, this method can be widely applied.

1. An information coding and transmission method that is based on UDP network transmission protocol and characterized in inclusion of the following procedures:
(1) Definition of data transmitting terminal A, which is a device connected to the encrypted WLAN and capable of transmitting to other network addresses by adoption of connectionless UDP network transmission protocol;
(2) Definition of data transmitting terminal B, which is a device not connected to the abovementioned WLAN but capable of wireless network functions, while data transmitting terminals A and B are in the coverage range of the same wireless network signals;
(3) Pre-agreement between terminal transmitting terminals A and B: preset a time period length n and the byte length of information sent during this time period length. Define different characteristic value m (0 or 1) for Bit s in every byte of the data byte sequence sent to data transmitting terminal B according to the different length s of the actual data byte sequence sent to data transmitting terminal B;
(4) Establishment of mapping relationship between data transmitting terminals A and B: data transmitting terminal A sends data of the same length s for more than one time to data transmitting terminal B during preset time period n, to complete transmission and communication of UDP data.

2. An information coding and transmission method that is based on UDP network transmission protocol as stated in claim 1, which is characterized in that the said actual byte length sent to data transmitting terminal B is less than the preset byte length sent during the time period length n.
